(19) United States
(12) Patent Application Publication
(10) Pub. No.: US 2012/0111750 A1
(43) Pub. Date: May 10, 2012

(54) CONTAINER FOR FASTENERS

(76) Inventor: Steven Michael Phillips, Dallas, TX (US)

(21) Appl. No.: 12/940,636

(22) Filed: Nov. 5, 2010

(51) Int. Cl. B65D 85/24; B29C 67/00

(52) U.S. Cl. 206/338; 264/334

(57) ABSTRACT

A container for fasteners is disclosed. In one configuration, the container includes a compartment for housing fasteners, a lid disposed over the compartment, and an attachment element. The lid and the compartment are coupled using a hinge and male and female latch elements. The lid includes a foldable display tag with an opening therein that facilitates placement of the container in a retail display. When the display tag is in a folded position, it is adapted to fold into a tag recess defined in the lid top. A notch defined in the lid facilitates positioning the display tag in an upright position.

### BACKGROUND OF THE INVENTION

1. Field of the Invention

The field of the invention is containers for fasteners, particularly display containers for collated fasteners.

2. Background

Because of improvements in nail gun and screw gun technology, the use of collated nails and screws has increased. Previously, collated fasteners were primarily used by professional contractors and purchased in bulk quantities, typically for use on larger construction projects. For these types of projects, collated fasteners are still shipped directly to job sites in cumbersome, bulky containers that house thousands of fasteners. Because of the large quantities involved, these containers are often made of easily conformable materials like corrugated cardboard. Unfortunately, this type of packaging has several disadvantages. To state a few, they easily tear and degrade under certain weather conditions.

Due to increased and varied use, collated fasteners are no longer used primarily by professional contractors for larger construction jobs. Rather, these types of fasteners are used by a large cross-section of persons, including do-it-yourselfers and professional contractors who appreciate the ease of use these types of fasteners provide. While attempts have been made to manufacture smaller containers for collated fasteners, those attempts have not fully considered the needs of sellers and users of collated fasteners.

Sellers often desire to display collated fastener containers in areas that are easily visible and accessible to buyers. In the check out line, for example, sellers often display small containers for customers considering whether to make a last minute purchase. Sellers may also desire to display smaller containers of collated fasteners where shelf space is limited.

Users of collated fasteners have additional needs that have not been addressed by prior art fastener containers. For example, users of collated fasteners frequently use tool belts and will benefit from a fastener container that may be attached to a tool belt or other surfaces. Users will also benefit from fastener containers that are small enough to be contained within a tool box for easy transport from one job site to another. Moreover, users will benefit from reusable fastener containers that are adapted for easy access to various types of fasteners. Given these considerations, among others, there is a clearly a need for improved containers for collated fasteners.

### SUMMARY OF THE INVENTION

The present invention is directed toward a container for fasteners. The container includes a compartment, including an open top for housing and easy access to fasteners, and a lid disposed over the compartment, including an open bottom. The lid and the compartment are coupled using a hinge.

The compartment includes a compartment front wall, a compartment back wall, a first compartment side wall, a second compartment side wall, and a bottom. The compartment front wall and compartment back wall are opposing, as are the first compartment side wall and the second compartment side wall. The compartment back wall has a longer vertical length than the compartment front wall such that the top edges of the compartment side walls are slanted downwardly from back to front. The positioning of these walls and edges allows a user to easily pick up fasteners within the compartment.

The lid of the container is disposed over the compartment that houses the fasteners. The lid includes an open bottom that rests on the open top of the compartment. The lid also may also include a lid top that has a display tag. The display tag is adapted to fold into a tag recess defined in the lid top. The lid includes a lid front wall, a lid back wall, a first lid sidewall, and a second lid sidewall. The lid front wall and the lid back wall are opposing, as are the first lid sidewall and the second lid sidewall. The lid front wall is longer than the lid back wall such that the bottom edges of the first sidewall and the second sidewall are slanted, allowing the lid to rest upon the complementary slant of the compartment side walls.

The container also has a latch that preferably includes a male latch element positioned on the compartment front wall and a female latch element positioned on the lid front wall. Other types of latches, however, may be suitable as long as they provide for sufficient closure. In one configuration, the male and female latch elements mate for closure of the display container. When a user desires to open the display container, a channel along the compartment front wall facilitates access by a user to the female latch element.

Additional options may be included as part of the display container. In one option, an attachment element is positioned upon one of the side walls to facilitate attachment to a tool belt or other surface. In another option, to easily transition the display tag from a folded position to an upright position, a notch is included on the lid top. In yet another option, a label extends along at least the first compartment sidewall and the first lid sidewall. This label may optionally be perforated to facilitate opening of the container.

Accordingly, a container for fasteners is disclosed. Advantages of embodiments of the invention will appear from the drawings and the detailed description.

### BRIEF DESCRIPTION OF THE DRAWINGS

FIG. 1 is a right perspective view of an open container for fasteners;

FIG. 2 is a right perspective view of a closed container for fasteners;

FIG. 3 is a left perspective view of an open container with fasteners stored therein, illustrating a product label thereon;

FIG. 4 is a left perspective view of the container of FIG. 3, shown in a closed position with the display tag in an upright position;

FIG. 5 is a top view of the container shown in FIG. 4;

FIG. 6 is a side view of the container shown in FIG. 4, illustrating a product label thereon; and

FIG. 7 is a sectional view of the container shown in FIG. 4, taken along line 7-7 of FIG. 5.

### DETAILED DESCRIPTION

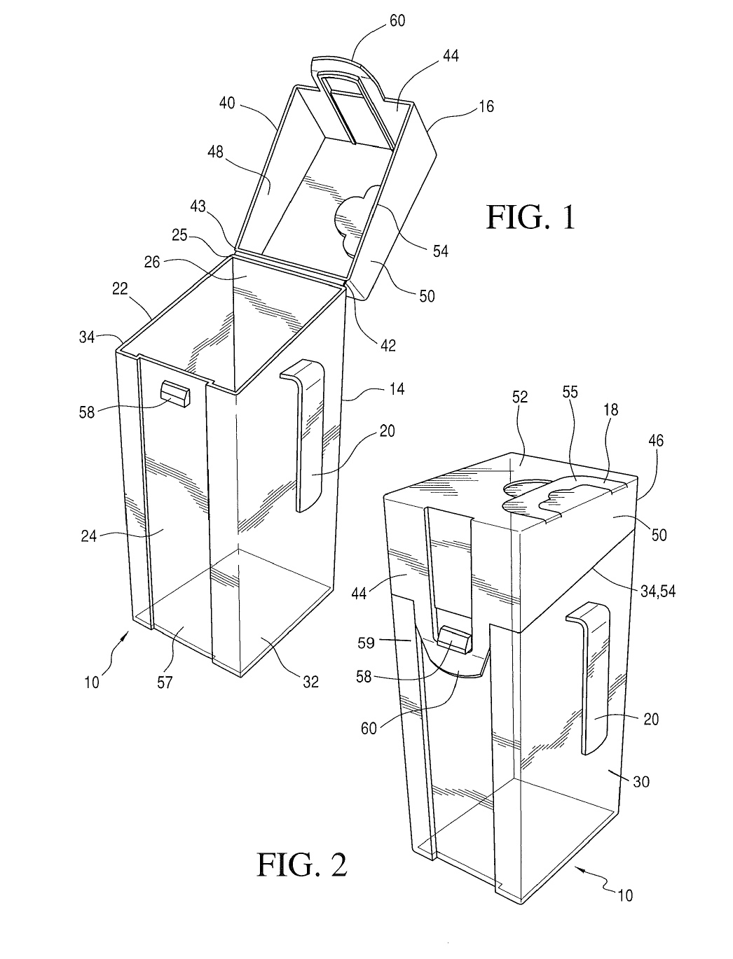

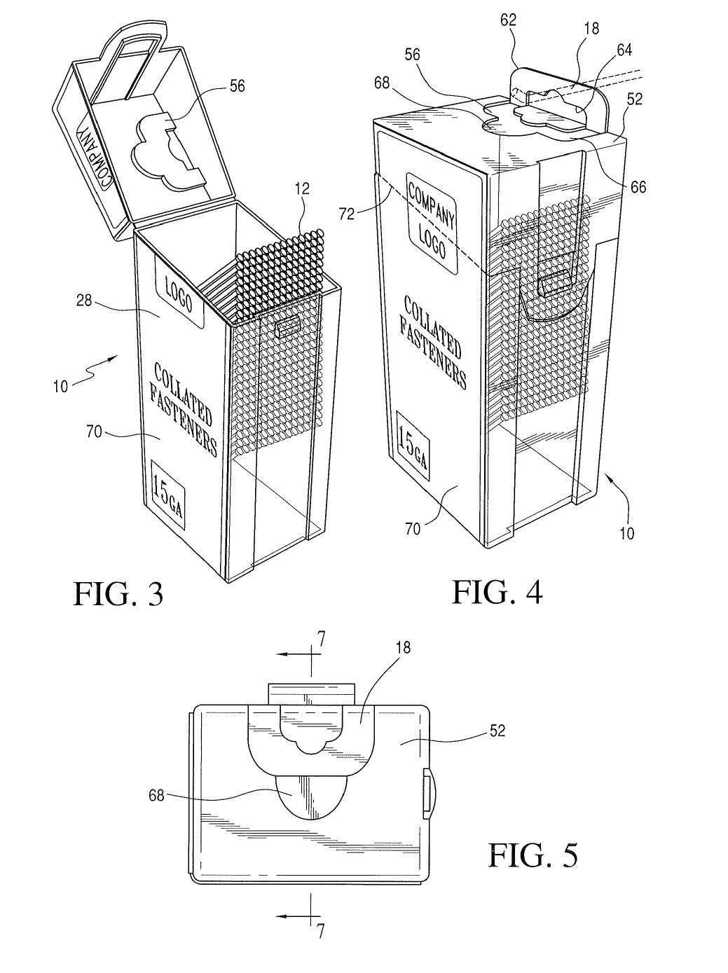

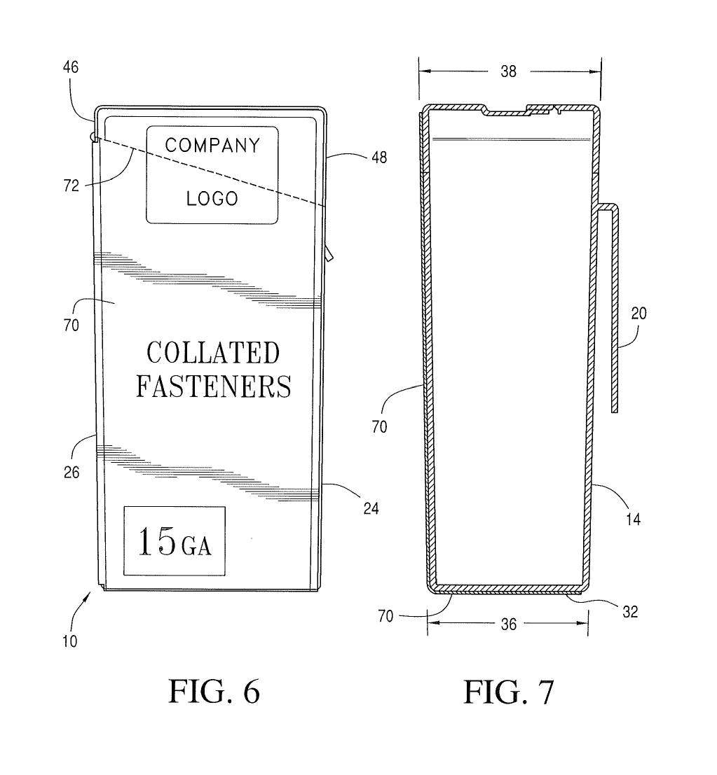

Turning in detail to the drawings, FIGS. 1-7 illustrate a container 10 which is designed for use with fasteners 12 (shown in FIGS. 3 and 4). In one configuration, the fasteners are angled collated finish nails; however, the container may be used with various types of fasteners, including nails or screws, with or without collation.

Preferably, the container 10 is formed in a mold, using a durable, impact resistant and weather resistant plastic material. Suitable materials include, but are not limited to, polypropylene and ABS plastic. More preferably, the plastic is semi-opaque such that positioning and type of the fasteners within the container are visible. If made from plastic, the container may be made using any available technique including, but not limited to, injection molding, blow molding, rotational molding, compression molding, and resin transfer molding (RTM). Where molding is the forming technique used for the container 10, steps in forming the container 10 comprise inserting a plastic material into a mold, molding the plastic material to form a container for the fasteners, and ejecting the formed container from the mold.

The forming techniques and materials mentioned, however, are not to be construed as limiting. The container 10 may be made from any suitable material, including die cast aluminum and composite materials. In addition, the various components of the container 10 may be formed from any combination of materials.

The container 10 may be designed to hold various sizes of fasteners including:

(1) 800-1,000, 15 Gauge Angled Collated Finish Nails 1″ long to 2½″ long.

(2) 800-1000, 18 Gauge Straight Brads ⅝″ long to 2⅛″ long.

(3) 800-1000, 18 Gauge ¼″ Crown Staples ⅜″ long to 1½″ long.

(4) 800-1000, 18 Gauge ⅜″ Crown Staples ⅝″ long to 1½″ long.

(5) 800-1000, 16 Gauge Straight Brads ¾″ long to 2½″ long.

(6) 800-1000, 16 Gauge Angled Brads ¾″ long to 2½″ long.

(7) 1000-5000 23 Gauge Headless Pins ½″ long to 2″ long.

(8) 1000-5000 22 Gauge Hammer Tacker Staples ¼″ long to ⅜″ long.

(9) 1000-5000 22 Gauge Upholstery Staples ¼″ to ⅝″ long.

In one embodiment, the container 10 includes, in part, a compartment 14, a lid 16, a display tag 18, an attachment element 20, and a latch 59.

The compartment 14 has a shape adapted to house fasteners, such as nails or screws. The compartment 14 has an open top 22 that is defined by a compartment front wall 24, a compartment back wall 26, a first compartment sidewall 28, a second compartment sidewall 30, and a bottom 32. The walls of the compartment are joined to form the compartment 14 and to define the open top 22. The compartment back wall 26 has a longer vertical length than the compartment front wall 24 such that the compartment sidewalls 28, 30 form slanted top edges 34. This configuration allows for a portion of the collated fasteners 12, positioned in straight or angled collation, to extend above the open top 22, allowing for easy grasp of the collated fasteners 12 by a user (See FIG. 3). The bottom 32 of sidewalls 28, 30 may also be slightly tapered inwardly (See FIG. 7) so that the compartment 14 has a narrower bottom profile 36 at the bottom 32 with respect to an upper profile 38 at the open top 22. This taper facilitates a manual grasp of the container 10 at its bottom 32. The narrower bottom profile 36 fits more easily within the hand of a user holding the container 10.

The lid 16 is movable between an open position and a closed position. In the open position, as shown in FIGS. 1 and 3, the lid 16 has an open bottom 40. As shown in FIGS. 2 and 4, the lid 16 rests on the open top 22 of the compartment 14 when the container 10 is in a closed position. The lid 16 is further defined by a lid front wall 44, a lid back wall 46, a first lid sidewall 48, a second lid sidewall 50, and a lid top 52. The walls of the lid 16 are joined to define the open bottom 40. The lid front wall 44 has a longer vertical length than the lid back wall 46 such that the lid sidewalls 48, 50 are disposed to form slanted bottom edges 54.

With reference to FIG. 1, a hinge 42 is used to pivotally connect the lid 16 to the compartment 14. Preferably, the hinge 42 is disposed between a lid back edge 43 and a compartment back edge 25. More preferably, the hinge 42 is a living hinge that is disposed partially or fully between these respective edges 25, 43. The hinge 42 also has sufficient strength and elasticity to allow for repeated opening and closing of the lid 16 without breakage of the hinge 42.

Connected to the lid top 52 is a display tag 18 (See FIGS. 2, 4, and 5). The display tag 18 is adapted for positioning in upright and folded positions. When the display tag 18 is folded into the lid top 52 (FIG. 2), the top 55 of the tag is substantially flat and substantially coplanar with the lid top 52. The outer profile 62 of the display tag 18 may be any shape. However, in one embodiment, the outer profile of the display tag 18 has at least three sides. The inner profile 64 of the tag is shaped to facilitate placement of the container 10 in a retail display. The inner profile 64 of the tag is adapted to receive a display hook of any shape (shown in phantom in FIG. 4). When the display tag 18 is in a folded position, it is adapted to fold into a tag recess 56 defined in the lid top (See FIGS. 5 and 7). The tag recess 56 has a recess profile 66 similar to the outer profile 62 of the display tag 18 and, preferably, with an added notch 68 discussed below. Depending upon the size of the container, the tag recess 56 has a depth ranging from approximately 0.051 inches [1.3 millimeters] to 0.063 inches [1.6 millimeters].

To facilitate movement of the display tag 18 into an upright position a notch 68 is also included in the lid top 52. The notch 68 is of a shape that is suitable for placement of a user's fingernail or a tool, e.g. a flat head screwdriver, that can be used to move the display tag 18 into its upright position.

The container 10 also has a latch 59. Although the latch may be of any type and in any configuration, preferably the latch 59 includes a male latch element 58 positioned on the compartment front wall 24 and a female latch element 60 positioned on the lid front wall 44 or channel 57. Alternatively, these latch elements may be positioned on other mating walls, providing for closure of the display container. For example, the female latch element may be positioned on the compartment front wall, while the male latch element is positioned on the lid front wall. These latch elements 58, 60 mate for closure of the container 10, as shown in FIG. 2. A user need only move the female latch element 60 away from the male latch element 58 to release the latch 59.

A channel 57 positioned on the compartment front wall 24 also facilitates release of the latch by a user. Preferably, the channel 57 extends along the entire length of the compartment front wall 24. The channel 57 may, however, extend a shorter length along the compartment front wall 24. Depending upon the size of the display container, the channel 57 has a depth ranging from approximately 0.076 inches [1.93 millimeters] to 0.084 inches [2.13 millimeters]. In one configuration, the male latch element 58 is positioned on the channel 57. The male latch element 58 preferably extends horizontally from the channel 57 until flush with the compartment front wall 24. Optionally, the male latch element 58 includes a hook extension (not shown) to provide for additional engagement with the female latch element 60. The female latch element 60 preferably extends vertically from the lid front wall 44.

As shown in FIGS. 1, 2, and 7, the container 10 can further comprise an attachment element 20 adapted to engage one of the compartment sidewalls 28, 30. Depending on the size of the container, the attachment element 20 is preferably “L” shaped and extends a distance along one sidewall of the container 10 sufficient to hold it in place. The attachment element 20 is adapted to engage a surface (not shown) such as a wall or a tool belt to facilitate access to the fasteners and opening of the lid. Placement of the attachment element 20 on a compartment sidewall versus a compartment front or back wall facilitates opening of the container 10. More specifically, with the attachment element 20 so positioned, the lid 16 opens away from, not into, the surface to which it is attached. Thus when the container 10 is attached to a worker's belt the lid 16 can be fully rotated into a full open position alongside the body of the worker. This placement of attachment element 20 also enables easier alignment of the front of container 10 with the front of a user thereby enabling easier access to the latch 59.

As shown in FIGS. 3, 4, and 6, the container 10 also includes a label 70 that adheres to the container 10. Any adhesive that is compatible with the container material is suitable. The label 70 can include any information, including product, supplier, and manufacturer information. The label 70 is tamper resistant and designed to indicate whether the container 10 has been tampered with. In one configuration, the label 70 is adapted to extend along at least one compartment sidewall and at least one lid sidewall. The label 70 may, however, extend upon other walls, including the lid top 52, or the bottom 32 of the compartment. Preferably, the label 70 extends without interruption on the first compartment sidewall 28, the first lid sidewall 48, the compartment back wall 26, the lid back wall 46, and the bottom 32 of the compartment so as to be viewable no matter how the container is displayed.

Optionally, the label 70 is provided with a perforated section 72 that corresponds to slanted edges 34, 54 (See FIG. 4). This perforated section 72 allows a user to open the container 10 without significant effort.

After a user depletes the initial supply of collated fasteners, the container 10 may be reused by filling it with other types of fasteners or other tool accessories. Moreover, a user may fill the container 10 with any product for later storage.

Thus, a container for fasteners is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A container for fasteners comprising:
a compartment for housing fasteners, including an open top, comprising:
a compartment front wall,
a compartment back wall, wherein the compartment front wall and the compartment back wall are opposing,
a first compartment sidewall,
a second compartment sidewall, wherein the first compartment sidewall and the second compartment sidewall are opposing, and
a bottom; and
a lid hingably connected to and disposed over the compartment, including an open bottom, comprising:
a lid top,
a lid front wall, and
a lid back wall, wherein the lid front wall and the lid back wall are opposing,
a first lid sidewall, and
a second lid sidewall, wherein the first lid sidewall and the second lid sidewall are opposing.

2. The container of claim 1, further comprising a display tag adapted to fold into a tag recess defined in the lid top

3. The container of claim 1, further comprising a latch.

4. The container of claim 3, wherein the latch includes a male latch element attached to the compartment and adapted for connection to a female latch element attached to the lid.

5. The container of claim 1, further comprising a hinge disposed between the compartment back wall and the lid back wall.

6. The container of claim 5, wherein the hinge is a living hinge.

7. The container of claim 4, further comprising a recess disposed in the compartment front wall aligned with the latch.

8. The container of claim 1, further comprising a label.

9. The container of claim 8, wherein the label has a perforation thereon corresponding to a juncture of a container sidewall and a lid sidewall.

10. The container of claim 1, further comprising an attachment element disposed on a compartment sidewall.

11. The container of claim 1, wherein the container is adapted to house collated fasteners.

12. The container of claim 1, wherein the container is adapted to house non-collated fasteners.

13. The container of claim 1, wherein the compartment is elongated.

14. The container of claim 1, wherein the compartment is tapered.

15. The container of claim 1, wherein the compartment back wall is longer than the compartment front wall.

16. The container of claim 1, wherein the first compartment sidewall and the second compartment sidewall have slanted top edges.

17. The container of claim 1, wherein the first lid sidewall and the second lid sidewall have slanted bottom edges.

18. The container of claim 2, further comprising a notch disposed on the lid top.

19. The container of claim 18, wherein the notch allows for positioning of the display tag in an upright position.

20. A method of molding a container for fasteners comprising:
inserting a plastic material into a mold;
molding the plastic material to form the container for fasteners, the container comprising:
a compartment for housing fasteners, including an open top, comprising:
a compartment front wall,
a compartment back wall, wherein the compartment front wall and the compartment back wall are opposing,
a first compartment sidewall,
a second compartment sidewall, wherein the first compartment sidewall and the second compartment sidewall are opposing, and
a bottom; and
a lid disposed over the compartment, including an open bottom, comprising:
a lid top,
a lid front wall, and
a lid back wall, wherein the lid front wall and the lid back wall are opposing,
a first lid sidewall, and
a second lid sidewall, wherein the first lid sidewall and the second lid sidewall are opposing; and
ejecting the container from the mold.
